(19) United States
(12) Patent Application Publication
(10) Pub. No.: US 2019/0240892 A1
(43) Pub. Date: Aug. 8, 2019

(54) PRE-IMPREGNATED PART COMPRISING A MAIN LAYER AND A REINFORCING LAYER

(71) Applicant: FAURECIA SYSTEMES D'ECHAPPEMENT, Nanterre (FR)

(72) Inventor: Thierry RENAULT, DINARD (FR)

(21) Appl. No.: 16/263,509

(22) Filed: Jan. 31, 2019

(30) Foreign Application Priority Data
Feb. 5, 2018 (FR) 18 50941

(51) Int. Cl. B29C 51/14; B29C 70/02

(52) U.S. Cl. CPC B29C 51/145; B29C 70/02

(57) ABSTRACT

A pre-impregnated part includes a main layer and a reinforcing layer. The main layer is made from a first composite material including a first matrix made from thermoplastic material, and first reinforcing fibers embedded in the first matrix. The reinforcing layer is made from a second composite material including a second matrix made from thermoplastic material, and second reinforcing fibers embedded in the second matrix. The pre-impregnated part has a flattened shape of at least a portion of a finished part to be manufactured from said pre-impregnated part, and a surface of the main layer is smaller than a developed surface of the finished part to be manufactured.

### CROSS-REFERENCE TO RELATED APPLICATIONS

This application is a U.S. non-provisional application claiming the benefit of French Patent Application No. 18 50941, filed on Feb. 5, 2018, which is incorporated herein by its entirety.

### FIELD OF INVENTION

The present invention relates to a pre-impregnated part, usable thermoplastically and intended to manufacture a finished part made from composite material, the pre-impregnated part comprising:
a main layer made from a first composite material including a first matrix made from thermoplastic material and first reinforcing fibers embedded in the first matrix, the main layer being obtained from a main complex including at least a first layer of fibers comprising at least the first reinforcing fibers and at least a first matrix layer comprising the thermoplastic material; and
a reinforcing layer made from a second composite material including a second matrix made from thermoplastic material and second reinforcing fibers embedded in the second matrix, the reinforcing layer being obtained from a reinforcing complex including at least a second layer of fibers comprising at least the second reinforcing fibers and at least a second matrix layer comprising the thermoplastic material, said reinforcing layer being fixed on at least part of the main layer.

### BACKGROUND OF THE INVENTION

Such parts of the aforementioned type are known, also known under the name “organosheet”. Such a pre-impregnated part is intended to be shaped, and optionally associated with other pre-impregnated parts, to manufacture a light finished part having satisfactory mechanical parts, for example, by stamping and/or overmolding. The finished parts are, for example, used in the automotive industry to form vehicle body parts, reinforcing or protective panels, seat parts or the like.

However, such a part is not fully satisfactory. Indeed, it is manufactured continuously by passing strips of fibers and strips of thermoplastic material between heated rollers so that the thermoplastic material impregnates the fibers. Such a manufacturing method in a double strip press makes it possible to produce a prepreg strip with a uniform shape, of uniform thickness and surface, which is therefore not adapted to the shape of the finished part to be manufactured. The strip must thus be reworked by cutting it. The uniform shape and thickness of such a part are also not suitable for reinforcing certain portions of the finished part without additional steps.

### SUMMARY OF THE INVENTION

One aim of the invention is to propose a pre-impregnated part ready to produce a finished part including at least one reinforced portion.

To that end, the invention relates to a pre-impregnated part having the flattened shape of at least a portion of the finished part to be manufactured from said pre-impregnated part, the surface of the main layer being smaller than the developed surface of the part to be manufactured.

By manufacturing the pre-impregnated part from the main complex and a reinforcing complex, the shape, the surface, and the mechanical characteristics of the pre-impregnated part are made highly configurable by adapting the characteristics of the complexes, such as their shape, their thickness and/or their surface, to the desired characteristics of the pre-impregnated part. One thus obtains a pre-impregnated part having characteristics, such as its shape and its surface, bringing it closer to the finished part to be manufactured. Thus, it is not necessary to rework the pre-impregnated part before manufacturing the finished part from this pre-impregnated part.

According to specific embodiments of the invention, the pre-impregnated part further has one or more of the following features, considered alone or according to any technically possible combination(s):
the reinforcing layer has a surface area different from that of the main layer;
the main layer has a thickness different from that of the reinforcing layer;
the weave of the first reinforcing fibers in the main layer is different from that of the second reinforcing fibers in the reinforcing layer;
in the main complex and/or the reinforcing complex, at least two layers of matrix extend on either side of at least one layer of fibers;
the main complex and/or the reinforcing complex include at least two layers of fibers, each layer of fibers extending between a layer of matrix on its first face and a layer of matrix on its second face;
the first reinforcing fibers of the main layer have a different orientation from the second reinforcing fibers of the reinforcing layer;
the grammage of the first matrix layer and/or the second matrix layer is between 100 and 700 g/m², and wherein the thickness of the pre-impregnated part is between 0.5 and 10 mm;
the fiber and matrix layers of the main complex are joined to one another at least punctually, and/or
the fiber and matrix layers of the reinforcing complex are joined to one another at least punctually, and/or
the main complex and the reinforcing complex are joined to one another at least punctually.

The invention also relates to the use of the pre-impregnated part described above to produce at least one finished part by thermostamping and/or overmolding.

### BRIEF DESCRIPTION OF THE DRAWINGS

Other features and advantages of the invention will appear upon reading the following description, provided solely as an example and done in reference to the appended drawings, in which:

FIG. 1 is a top view of a pre-impregnated part according to the invention;

FIG. 2 is a sectional view along line A-A′ of FIG. 1 of the layers of the main complex and the reinforcing complex before impregnation of the fibers by the thermoplastic material to obtain the pre-impregnated part; and

FIG. 3 is a sectional view of a pre-impregnated part obtained from the stack shown in FIG. 2.

### DETAILED DESCRIPTION

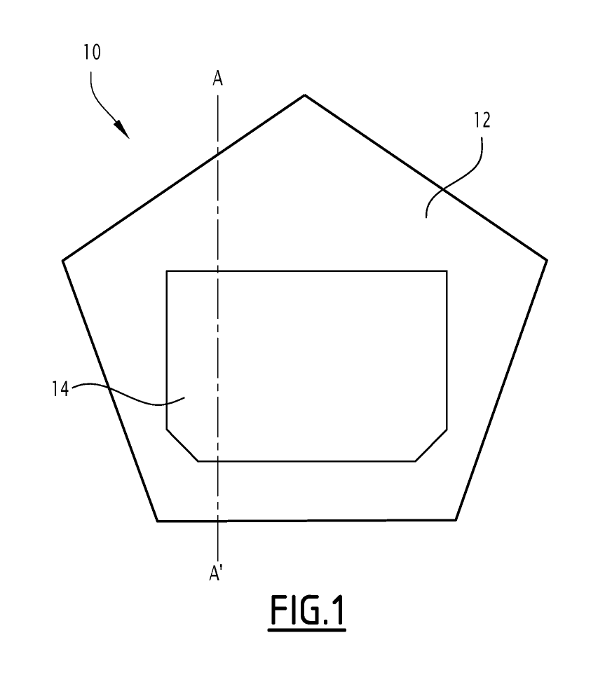

In reference to FIG. 1, a pre-impregnated part 10 is described intended to manufacture a finished part made from composite material. Such a pre-impregnated part 10 is also known under the name “organosheet”.

The pre-impregnated part 10 assumes the form of a substantially planar plate having a shape corresponding to at least a portion of the shape of the finished part to be manufactured from the flattened pre-impregnated part 10.

The pre-impregnated part 10 is intended to produce a finished part, for example three-dimensional, by thermostamping and/or overmolding. Thermostamping includes positioning the pre-impregnated part 10, and optionally other pre-impregnated parts, in a heated press, the press being arranged to impart the shape of the finished part to the pre-impregnated part 10. Overmolding includes positioning the pre-impregnated part 10, optionally shaped in a press, in a molding cavity having the shape of the finished part to be produced and injecting a molding material in the cavity around the pre-impregnated part 10 to produce the finished part.

The thickness of the pre-impregnated part 10 is between 0.5 and 10 mm, preferably between 0.5 and 5 mm, and still more preferably between 0.5 and 2 mm.

The pre-impregnated part 10 comprises a main layer 12 and a reinforcing layer 14.

The surface of the main layer 12 is smaller than the developed surface of the finished part to be manufactured from the pre-impregnated part 10. Thus, the pre-impregnated part 10 has a shape and a surface adapted to the production of the desired finished part without having to re-cut the pre-impregnated part 10. In other words, the pre-impregnated part 10 is “ready to use” and may be used without modification to manufacture the desired finished part.

Advantageously, the main layer 12 has a non-rectangular shape corresponding to at least part of the shape of the flattened finished part.

The main layer 12 has a thickness different from that of the reinforcing layer 14.

The reinforcing layer 14 is attached on at least part of the main layer 12.

According to an embodiment shown in FIG. 1, the reinforcing layer 14 has a surface area different from that of the main layer 12. Advantageously, the surface area of the reinforcing layer 14 is lower than the surface area of the main layer 12. The reinforcing layer 14 is thus positioned on a localized zone of the main layer 12 in which reinforced mechanical properties are desired. In other words, the pre-impregnated part 10 has different mechanical characteristics in the zone of the main layer 12 not covered by the reinforcing layer 14 and in the zone of the main layer 12 covered by the reinforcing layer 14.

In reference to FIG. 3, the main layer 12 is made from a first composite material including a first matrix 16 made from thermoplastic material, and first reinforcing fibers 18 embedded in the first matrix 16.

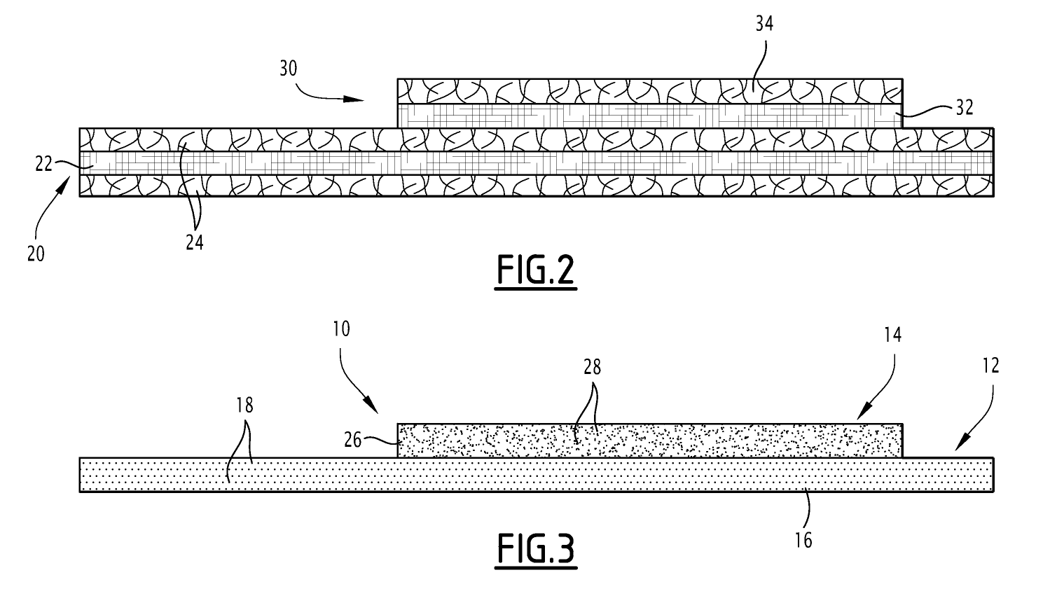

As shown in FIG. 2, the main layer 12 is obtained from a main complex 20. The main complex 20 includes at least a first layer of fibers 22, and at least a first matrix layer 24 comprising the thermoplastic material.

Similarly, in reference to FIG. 3, the reinforcing layer 14 is made from a second composite material including a second matrix 26 made from thermoplastic material, and second reinforcing fibers 28 embedded in the second matrix 26.

As shown in FIG. 2, the reinforcing layer 14 is obtained from a reinforcing complex 30. The reinforcing complex 30 includes at least a second layer of fibers 32, and at least a second matrix layer 34 comprising the thermoplastic material.

Advantageously, in the main complex 20 and/or the reinforcing complex 30, at least two matrix layers 24, 34 extend on either side of at least one layer of fibers 22, 32.

Advantageously, the main complex 20 and/or the reinforcing complex 30 include at least two layers of fibers 22, 32, each layer of fibers 22, 32 extending between a matrix layer 24, 34 on its first face and a matrix layer 24, 34 on its second face.

The first and second reinforcing fibers 18, 28 are, for example, glass fibers, or carbon fibers, aramid fibers, basalt fibers, natural fibers or the like. The first and second reinforcing fibers 18, 28 may also be a mixture of said fibers. According to one embodiment, the first reinforcing fibers 18 of the first composite material are of the same nature as the second reinforcing fibers 28 of the second composite material. Alternatively, the first and second reinforcing fibers 18, 28 are different.

The first and second reinforcing fibers 18, 28 respectively embedded in the first and second matrices 16, 26 come from the first and second layers of fibers 22, 32 comprising first and second reinforcing fibers 18, 28.

In one embodiment of the invention, the weave of the first reinforcing fibers 18 in the main layer 12 is different from that of the second reinforcing fibers 28 in the reinforcing layer 14. In other words, the first reinforcing fibers 18 of the first layer of fibers 22 are woven differently from the second reinforcing fibers 28 of the second layer of fibers 32.

According to one embodiment, the first and second layers of fibers 22, 32 have continuous woven fibers, multiaxial fibers (non-crimp fabric), or layers made from fibers having random orientations. Advantageously, the layers of fibers 22, 32 have at least two different orientations of fibers, which makes it possible to improve the mechanical characteristics of the pre-impregnated part 10 in all directions thereof. According to one embodiment of the invention, the first reinforcing fibers 18 of the main layer 12 have a different orientation from the second reinforcing fibers 28 of the reinforcing layer 14.

The grammage of the first and second layers of fibers 22, 32 is for example between 100 and 1000 g/m², preferably between 300 and 800 g/m², still more preferably between 500 and 700 g/m², and is advantageously substantially equal to 600 g/m².

Such fibers are chosen to reinforce the finished part, which, for example, makes it possible to reduce its thickness while preserving satisfactory mechanical properties. Thus, the finished composite material part is made lighter relative to a part made solely from thermoplastic material while having identical, or even improved mechanical properties.

The thermoplastic material is, for example, polyethylene terephthalate (PET). PET has the advantage of being inexpensive relative to the thermoplastic materials generally used to produce the matrix of parts made from composite material. Other thermoplastic materials are also possible, for example polypropylene, polyamide 6, polyamide 66, polybutylene terephthalate (PBT), and the like. The thermoplastic material can be in the form of a nonwoven or a film. In the case of a nonwoven, the thickness of the first matrix layer 24 and the second matrix layer 34 before producing the pre-impregnated part 10 is greater than or equal to 1 mm, preferably between 1 and 5 mm, and still more preferably between 2 and 3 mm. In the case of a film, the thickness of the first matrix layer 24 and the second matrix layer 34 before producing the pre-impregnated part 10 is between 100 and 1000 μm, preferably between 150 and 500 μm, and still more preferably between 200 and 300 μm.

The grammage of the first and second matrix layers 24, 34 is. for example, between 100 and 700 g/m², preferably between 200 and 500 g/m², and is advantageously substantially equal to 300 g/m².

According to a first embodiment, the first and second matrix layers 24, 34 are made solely from thermoplastic material and the first and second layers of fiber 22, 32 are formed solely from reinforcing fibers.

According to a second embodiment, each matrix layer 24, 34 comprises from 10 to 100 wt % of thermoplastic material and from 0 to 90 wt % of reinforcing fibers, and each layer of fibers 22, 32 comprises from 10 to 100 wt % of reinforcing fibers and from 0 to 90 wt % of thermoplastic material.

Preferably, each matrix layer 24, 34 comprises from 50 to 80 wt % of thermoplastic material and from 20 to 50 wt % of reinforcing fibers, and each layer of fiber 22, 32 comprises from 60 to 90 wt % of reinforcing fibers and from 10 to 40 wt % of thermoplastic material.

According to a third embodiment, the first and/or second matrix layers 24, 34 and/or the first and/or second layers of fibers 22, 32 are semi-impregnated comprising a mixture of PET thermoplastic fibers and reinforcing fibers, such as a fabric of comingled fibers with reinforcing fibers and thermoplastic material fibers, or a co-woven fabric of reinforcing fibers and fibers of thermoplastic material. In the case of the fabric with comingled fibers and the co-woven fabric, the fibers of the thermoplastic material make up at least 10%, advantageously from 30% to 60%, by weight of the first and/or second matrix layers 24, 34. In the case of the fabric with comingled fibers and the co-woven fabric, the fibers of the thermoplastic material make up at least 10%, advantageously from 30% to 60%, by weight of the first and/or second fiber layers 22, 32.

Advantageously, at least one layer in the main complex 20 has a different thickness from at least one layer in the reinforcing complex 30. This makes it possible to vary the mechanical properties of the main layer 12 relative to the reinforcing layer 14 in the pre-impregnated part 10. According to one embodiment of the invention, the thickness of first fiber layer(s) 22 is different from that of second fiber layer(s) 32, and/or the thickness of first matrix layer(s) 24 is different from that of second matrix layer(s) 34.

Advantageously, the layers of the main complex 20 are joined to one another at least punctually, and/or the layers of the reinforcing complex 30 are joined to one another at least punctually, and/or the main complex 20 and the reinforcing complex 30 are joined to one another at least punctually. This advantageous embodiment allows better securing of the layers of the main complex 20 and/or the layers of the reinforcing complex 30 and/or the main complex 20 relative to the reinforcing complex 30 and makes the layers easier to handle for impregnation in order to obtain the pre-impregnated part 10.

According to one embodiment of the invention, the assembly of the main layer 12 and the reinforcing layer 14 is made up of layers stacked in the following order: fiber layer, matrix layer, matrix layer, fiber layer, matrix layer, matrix layer, fiber layer. According to another embodiment of the invention, the assembly of the main layer 12 and the reinforcing layer 14 is made up of layers stacked in the following order: fiber layer, matrix layer, matrix layer, fiber layer, matrix layer, fiber layer, matrix layer, matrix layer, fiber layer. According to another embodiment of the invention, the assembly of the main layer 12 and the reinforcing layer 14 is made up of layers stacked in the following order: matrix layer, fiber layer, matrix layer, fiber layer, matrix layer, fiber layer, matrix layer. It is understood that the number and order of the layers may vary depending on the desired properties of the pre-impregnated part 10 and/or the finished part to be produced.

Having a first composite material of the same nature as the second composite material, in particular by choosing an identical material to make the first matrix layer 24 and the second matrix layer 34, makes it possible to improve the cohesion of the pre-impregnated part 10 during the production thereof, the materials of these layers mingling with one another during the impregnation of the fibers. However, alternatively, the first matrix layer 24 can be made from a different material from the second matrix layer 34.

The pre-impregnated part 10 is obtained by arranging the stack of the main complex 20 and the reinforcing complex 30 in a production tool heated to a temperature higher than the melting temperature of the thermoplastic material of the first and second matrix layers 24, 34 and applying a pressure on the stack such that the melted thermoplastic material impregnates the fibers of the first and second fiber layers 22, 32 and such that the main and reinforcing layers 12, 14 are secured to one another. The main 20 and reinforcing 30 complexes are, for example, cut beforehand to the desired shape and surface area. The main 20 and reinforcing 30 complexes are next consolidated in a mold to a temperature below the melting temperature of the thermoplastic material.

Thanks to the invention described above, the manufacture of the finished part is made easier. In particular, the pre-impregnated part 10 including the reinforcing layer 14 configured to reinforce certain portions of the finished part, all that remains is a step for shaping the pre-impregnated part 10 and optionally an overmolding step for manufacturing the finished part having the appropriate reinforced portions, without using additional complicated steps for adapting the pre-impregnated part 10 to the finished part to be produced.

Thus, the non-rectangular shape of the main layer 12 corresponding to the flattened shape of at least a portion of the finished part makes it possible to do without cutting of the pre-impregnated part 10, which reduces the manufacturing time of the finished parts.

Furthermore, the pre-impregnated part 10 described above has satisfactory mechanical properties. Indeed, the pre-impregnated part 10 for example has a modulus in flexure greater than 20 GPa and a rupture stress greater than 400 MPa.

Although an embodiment of this invention has been disclosed, a worker of ordinary skill in this art would recognize that certain modifications would come within the scope of this disclosure. For that reason, the following claims should be studied to determine the true scope and content of this disclosure.

1. A pre-impregnated part, usable in a thermoplastic manner, and intended to manufacture a finished part made from composite material, the pre-impregnated part comprising:
a main layer made from a first composite material including a first matrix made from a thermoplastic material and first reinforcing fibers embedded in the first matrix, the main layer being obtained from a main complex including at least a first layer of fibers comprising at least the first reinforcing fibers and at least a first layer of matrix comprising the thermoplastic material,
a reinforcing layer made from a second composite material including a second matrix made from a thermoplastic material and second reinforcing fibers embedded in the second matrix, the reinforcing layer being obtained from a reinforcing complex including at least a second layer of fibers comprising at least the second reinforcing fibers and at least a second layer of matrix comprising the thermoplastic material, said reinforcing layer being fastened on at least a portion of the main layer, and
wherein the pre-impregnated part has a flattened shape of at least a portion of the finished part to be manufactured from said pre-impregnated part, and in that a surface of the main layer is smaller than a developed surface of the finished part to be manufactured.

2. The pre-impregnated part according to claim 1, wherein the reinforcing layer has a surface area different from that of the main layer.

3. The pre-impregnated part according to claim 1, wherein the main layer has a thickness different from that of the reinforcing layer.

4. The pre-impregnated part according to claim 1, wherein a weave of the first reinforcing fibers in the main layer is different from that of the second reinforcing fibers in the reinforcing layer.

5. The pre-impregnated part according to claim 1, wherein, in the main complex, at least two first layers of matrix extend on either side of the at least one first layer of fibers, and/or wherein, in the reinforcing complex, at least two second layers of matrix extend on either side of the at least one second layer of fibers.

6. The pre-impregnated part according to claim 1, wherein the main complex includes at least two first layers of fibers, each first layer of fibers extending between at least one first layer of matrix on a first face of the first layer of fibers and at least one first layer of matrix on a second face of the first layer of fibers, and/or
wherein the reinforcing complex includes at least two second layers of fibers, each second layer of fibers extending between at least one second layer of matrix on a first face of the second layer of fibers and at least one second layer of matrix on a second face of the second layer of fibers.

7. The pre-impregnated part according to claim 1, wherein the first reinforcing fibers of the main layer have a different orientation from the second reinforcing fibers of the reinforcing layer.

8. The pre-impregnated part according to claim 1, wherein a grammage of the first layer of matrix and/or the second layer of matrix is comprised between 100 and 700 g/m2, and wherein a thickness of the pre-impregnated part is comprised between 0.5 and 10 mm.

9. The pre-impregnated part according to claim 1, wherein:
the at least one first layer of fibers and the at least one first layer of matrix of the main complex are joined between one another at least punctually, and/or
the at least one second layer of fibers and the at least one second layer of matrix of the reinforcing complex are joined between one another at least punctually, and/or
the main complex and the reinforcing complex are joined between one another at least punctually.

10. A use of the pre-impregnated part made from composite material according to claim 1 to manufacture at least one finished part by thermo-stamping and/or over-molding.
